(19) United States
(12) Patent Application Publication
(10) Pub. No.: US 2018/0025656 A1
(43) Pub. Date: Jan. 25, 2018

(54) SEQUENCE OF CONTEXTS WEARABLE

(71) Applicant: KONINKLIJKE PHILIPS N.V., EINDHOVEN (NL)

(72) Inventors: JOHN CRONIN, BONITA SPRINGS, FL (US); SETH MELVIN CRONIN, BONITA SPRINGS, FL (US)

(21) Appl. No.: 15/547,902

(22) PCT Filed: Feb. 4, 2016
(86) PCT No.: PCT/IB2016/050555

§ 371 Date: Aug. 1, 2017

Related U.S. Application Data
(60) Provisional application No. 62/113,689, filed on Feb. 9, 2015.

(51) Int. Cl. G09B 5/06; G09B 19/00; G09B 5/04; G06Q 10/10; G09B 5/02

(52) U.S. Cl. CPC G09B 5/06; G06Q 10/1093; G09B 5/02; G09B 5/04; G09B 19/00; G06Q 30/0241

(57) ABSTRACT

In an embodiment, an apparatus comprising a processor (108) is presented that tracks a plurality of events experienced by a subject using data from wearable sensors (38) and network-connected devices (50), determines whether each of the events complies with a personalized schedule, and provides feedback related to the determination.

### FIELD OF THE INVENTION

The present invention is generally related to behavior management using data from wearable sensors and other devices.

### BACKGROUND OF THE INVENTION

Wearable technology may include any type of mobile electronic device that can be worn on the body, attached to or embedded in clothes and accessories of an individual and currently exists in the consumer marketplace. Processors and sensors associated with the wearable technology can display, process or gather information. Such wearable technology has been used in a variety of areas, including monitoring health data of the user as well as other types of data and statistics. For instance, in U.S. Pat. No. 7,107,539, a wearable computer is disclosed that gathers and uses contextual information, such as information about a user and the user's surroundings. Context servers (e.g., modules that provide attributes) receive data signals from input devices or other sources and then process such signals to produce context information. Attributes represent measures of specific context elements such as ambient temperature, latitude, and current user task expressed within fundamental data structures called “attributes”. Each attribute has a name and at least one value, and can additionally have other properties such as uncertainty, units and timestamp. Context servers provide attribute values and/or themes to a characterization module which in turn provides some or all of such information to the context clients (modules that process attributes). This general context framework encourages development of more abstract context information from simple data signals provided by input devices, because it provides a standard mechanism for the exchange of attribute values provided by context servers. For example, simple context information such as location signals provided by a global positioning system (GPS) receiver can be combined with other information such as ambient noise signals and video input cues to answer more abstract context questions such as “How busy am I?” or “What is my current activity?”. In particular, GPS signals may indicate over time that a user is traveling at a specific speed, and the wearable computer may recognize ambient noise as engine sounds, and thus recognize that the user is driving a car. Thus, such abstract context questions can be more intelligently answered using this contextual framework. Themes that include sets of multiple related attributes further enhance the contextual framework by permitting context clients or other code modules to provide a quantification or qualification of a useful context of the user that can not be directly measured from any attribute values in the set individually.

### SUMMARY OF THE INVENTION

One object of the present invention is to provide a wearable device that determines whether a subject is complying with a personalized schedule. To better address such concerns, in a first aspect of the invention, an apparatus comprising a processor is presented that tracks a plurality of events experienced by a subject using data from wearable sensors and network-connected devices, determines whether each of the events complies with a personalized schedule, and provides feedback related to the determination. The invention addresses a problem in the art of a subject having a schedule without knowing in real-time whether he or she is in compliance toward a particular goal for healthy behavior or other activities by providing real-time feedback data from wearable device sensors and Internet-connected devices of compliance or non-compliance.

In one embodiment, the processor, responsive to a determination that the first and second data do not correspond in time of receipt by the processor with a time component of the one of the stored contexts in the schedule of the first data structure, provides an alert to the subject. The time component may be embodied as an absolute time of day (e.g., time stamp), a time range, a relative time of day (e.g., thirty (30) minutes ago), or a time or range defined relative to an event or activity (e.g., thirty (30) minutes after dinner). By providing the alert, the subject is immediately enabled to react to non-compliance with the schedule, such as by responding with corrective behavior or, if beneficial, incorporation of the event within the schedule. For instance, in one embodiment, the alert may warn a subject that he or she is maintaining a certain state for too long, such as sitting too long in a chair, where the alert may further suggest a corrective behavior, such as to stand up or engage in other or additional activity.

In some embodiments, responsive to a determination that the first and second data correspond in time of receipt by the processor with a time component of the one of the stored contexts in the schedule of the first data structure, the processor is further configured to update the first data structure and further provide a message to the subject, the message conveying compliance by the subject with the schedule. The message serves to encourage positive behavior and hence promote healthy activity and/or behavior.

In some embodiments, the processor of the apparatus may provide the first and second data to a remote device or devices and receive information based on the determination that the first and second data correspond in time of receipt by the processor with the time component of the one of the stored contexts in the schedule of the first data structure, wherein the processor further causes a presentation of the information to the subject. For instance, the information may comprise an advertisement or other incentive that rewards (e.g., financially) and/or further encourages healthy behavior. In some instances, the information may be used to facilitate events in the schedule, such as finding a local gym or restaurant.

In one embodiment, the processor is further configured to cause a presentation of the first and second data and associated time component along with data of the first data structure and associated time components, the presentation further including a sensor range indication. For instance, visual and/or aural feedback of the events according to the personalized schedule may be presented to the subject to encourage good behavior or discourage unhelpful behavior, while placing in context readings from a sensor (e.g., a high pulse reading may be good while working out but not good if near bed time).

In one embodiment, prior to the receipt of the first and second data, the apparatus may operate in a learn mode, wherein the processor is further configured to automatically receive third data from at least one of a plurality of network connected devices; automatically receive fourth data from one or more of the wearable sensors, the fourth data corresponding to any one or a combination of a physiological and behavioral parameter; determine if there is a match between one of the events corresponding to a combination of the third and fourth data and a stored context having an associated context label; and responsive to the determination of a match, associate the one of the events with the stored context and a current time component, wherein responsive to each one of the events that the processor associates with a same one of the stored contexts a threshold plurality of times over the predetermined period of time, the processor is configured to automatically store the each one of the events as part of the personalized schedule in the first data structure along with a probability of an expected order of occurrence for the plurality of stored events. By automatically receiving data from wearable sensors and network-connected devices and upon monitoring repetitive events occurring over the course of time, a personalized schedule may be established with little or no subject intervention, which the apparatus may use to inform the subject of compliance or non-compliance on a continual basis.

These and other aspects of the invention will be apparent from and elucidated with reference to the embodiment(s) described hereinafter.

### BRIEF DESCRIPTION OF THE DRAWINGS

Many aspects of the invention can be better understood with reference to the following drawings, which are diagrammatic. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram that illustrates a system comprising an embodiment of a wearable device communicating with a remote device of a wearable context network and other devices that may be connected to a network in accordance with an embodiment of the invention.

FIG. 2 is a schematic diagram that illustrates an example table of information that may be stored in a lookup context database in accordance with an embodiment of the invention.

FIG. 3 is a schematic diagram that illustrates an example table of information that may be stored in an example ideal sequence database that corresponds to an ideal sequence of events that a subject of a wearable device may follow throughout a day in accordance with an embodiment of the invention.

FIG. 4 is a schematic diagram that illustrates an example table that may be stored in an ideal sensor database in accordance with an embodiment of the invention.

FIG. 5 is a schematic diagram that illustrates an example architecture for an apparatus that may be utilized to implement the various features and processes described herein in accordance with an embodiment of the invention.

FIG. 6 is a flow diagram that illustrates an example process performed by sequence build software running on a processor of a wearable device in accordance with an embodiment of the invention.

FIG. 7 is a flow diagram that illustrates an example process performed by example base software running on a processor of a wearable device in accordance with an embodiment of the invention.

FIG. 8 is a flow diagram that illustrates an example process performed by context detection software and sequence software running on a processor of a wearable device in accordance with an embodiment of the invention.

FIG. 9 is a flow diagram that illustrates an example process performed by network software that may run on a processor on a remote device of a wearable context network in accordance with an embodiment of the invention.

FIGS. 10A-11B are screen diagrams that illustrate example context alert and ideal sequence graphical user interfaces (GUIs) that may be displayed on a display screen of a wearable device in accordance with an embodiment of the invention.

FIG. 12 is a flow diagram that illustrates an example method that may be implemented in the system depicted in FIG. 1 in accordance with an embodiment of the invention.

### DETAILED DESCRIPTION OF EMBODIMENTS

Embodiments of the present invention comprise a wearable device (apparatus) and associated methods that collect information that corresponds to a series of events performed by a person wearing the wearable device. The wearable device may comprise a user interface, such as a display screen, that displays messages that may correspond to a repetitive event sequence. In certain instances the messages displayed may indicate that the activities or behavior of a subject (e.g., person) wearing the wearable device correspond to a desired sequence of events (e.g., in compliance with a personalized schedule). In other instances the messages may include information that indicates that the activities of a person do not correspond to a known repetitive sequence of events (e.g., not in compliance with a personalized schedule). The messages may also include one or more advertisements sourced from one or more advertiser or third-party devices, wherein the advertisements or other information may help the subject maintain a schedule. In one embodiment, the wearable device may initially collect information that identifies the actions of a person when learning (e.g., a learning mode) an activity or behavioral schedule of a person wearing the wearable device. In certain instances the wearable device may collect information from one or more network-connected (e.g., Internet-connected) devices when tracking or learning the activities of the person wearing the wearable device.

Digressing briefly, there are several example use cases where certain embodiments of a wearable device may track a sequence of events. For instance, the use cases may correspond to a work day, the eating habits of a person, traveling, and/or monthly and/or weekly routines. Each of the use cases generally include a series of events that may begin at the start time and end at an end time or that may correspond to a repetitive routine sequence of events. In a first example, a repetitive routine is a work day, where a user of a wearable device may experience the following events: wake up to an alarm, eat breakfast (e.g., as indicated by a signal from a smart fridge or other appliance), lock the door (e.g., as indicated by a signal from a smart lock), drive to work, and arrive at work. Each of these routines may occur at a specific time, or respective range of times. Detected deviations from this sequence by the wearable device may cause the wearable device to provide an alert to a user (e.g., human subject) of a wearable device notifying that he or she may be late for work (due to traffic), that he or she forgot to lock the door, and/or that he or she did not eat breakfast. For instance, the deviations represent non-compliance with the personalized schedule, and the alert is presented as feedback of the non-compliance. When such deviations occur the wearable device may display or transmit an alert message or a suggestion that may help a user of the wearable device maintain the schedule. An alert or suggestion may include sending an email to the boss, locking the door remotely, or recommending a breakfast vendor, among other examples.

Another example of a repetitive routine is an exercise routine where a user of a wearable device has a weekly routine of attending the gym on certain days, and doing certain workout exercises. If a wearable device detects that a user has completed multiple upper body workouts in a sequence (based upon connection to gym equipment and receipt of corresponding signals from that equipment), the wearable device (or mobile device or appliance coupled to the wearable device) may display a message on a display screen (or in some embodiments, provide audio feedback) that suggests that the user perform a lower body workout, including providing in some embodiments examples of lower body workout routines.

Yet another example of a repetitive routine is an eating habit where a user of the wearable device typically eats at home. After purchasing fast food at a vendor point of sale (POS) terminal (device) multiple days in a row, a message may be presented on a display screen at the wearable device (or to a coupled device) that recommends to the user a healthy alternative (e.g., suggest that the user eat a healthy meal, including examples of types of meals or meal ingredients).

Other examples of repetitive routines are contemplated. For instance, travelling may involve geolocation data from a wearable sensor (e.g., global navigation satellite systems (GNSS) receiver or from a GNSS receiver or transceiver in communication with the wearable device) that determines that a user is travelling a long distance and experiences a sequence of fueling the vehicle, purchasing food, and/or doing some form of recreation at certain times of the day. In one embodiment, the wearable device can alert the user when he or she may have forgotten to refill the gas tank, stop for food, and/or find some recreation, and deliver advertisements or other information for related services. It should be appreciated within the context of the present disclosure that the repetitive events may involve monthly, weekly, daily, hourly routines, among other routine periodicity. For instance, a user may have a sequence of activities such as Day 1—exercise, Day 2—watch TV, Day 3—exercise, Day 4—Craft/hobby, Day 5—Long Walk, Day 6—Clean House, Day 7—Go on a date. Certain embodiments of a wearable device may detect when the sequence has changed (e.g., in non-compliance), and suggest to the user through messaging or other forms of communication that he or she should either update the sequence or revisit activities which have been missed.

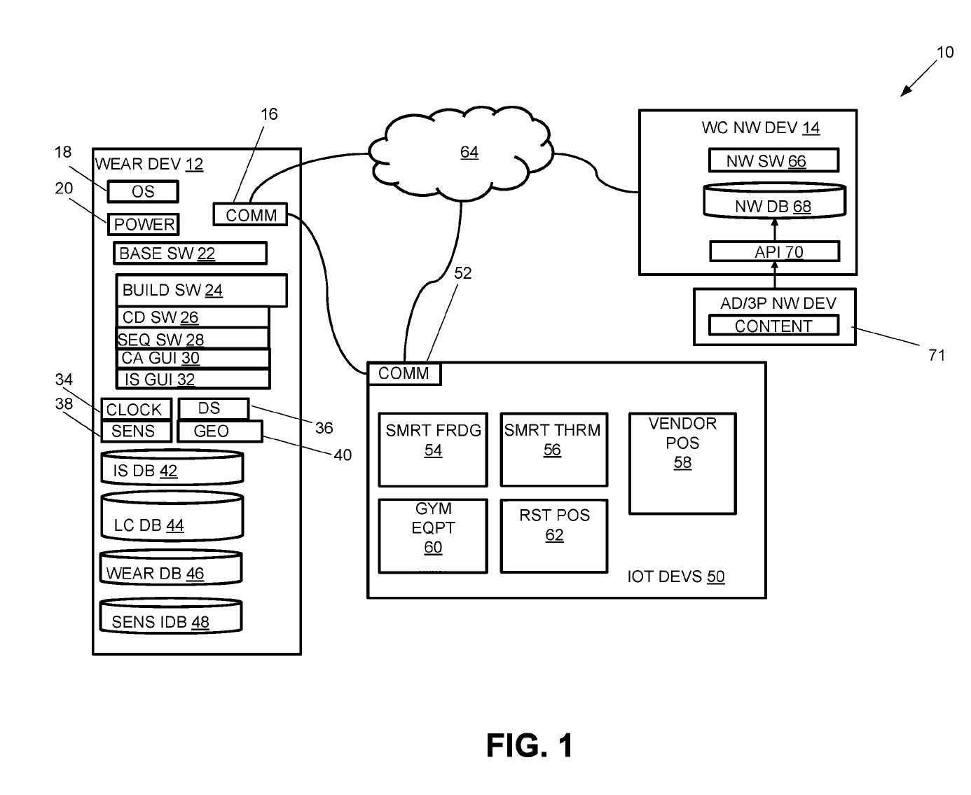

FIG. 1 illustrates a system 10 comprising a wearable device 12 communicating with one or more devices, such as remote device 14, of a wearable context network and other devices that may be connected to a network, such as the Internet. The wearable device 12 may communicate with the remote device 14 of the wearable context network or the Internet devices using a wireless data communication interface (COMM) 16. The present invention may use any known wireless data communication interface standards in the art. The wearable device 12 of FIG. 1 includes operating system software (OS) 18, a power supply (POWER) 20, the communication interface 16, base software (BASE) 22, sequence building software (BUILD SW) 24, context detection software (CD SW) 26, sequence software (SEQ SW) 28, a context alert GUI (CA GUI) 30, an ideal sequence GUI (IS GUI) 32, a clock 34, a display screen (DS) 36, one or more sensors (SENS) 38, a geo-location (e.g., GNSS) receiver (GEO) 40, an ideal sequence database (IS DB) 42, a lookup context database (LC DB) 44, a wearable database (WEAR DB) 46, and an ideal sensor database (SENS IDB) 48. Network connected devices illustrated in FIG. 1 comprise “Internet of things” (IOT) devices 50 that may communicate with the wearable device 12 and/or the devices 14 of the wearable context network over a communication interface (COMM) 52 over a network 64, which may comprise one or more networks, including a cloud computing network, the Internet, and/or other types of networks. The IOT devices 50 illustrated in FIG. 1 include a smart refrigerator (SMRT FRDG) 54, a smart thermostat (SMRT THRM) 56, a vendor lunch point-of-sale (POS) device 58 (e.g., such as in a cafeteria of a workplace, or other vendor location), device gym equipment (GYM EQPT) 60, and a restaurant device (62). Note that the communication interface 52 is depicted in FIG. 1 as coupled to each of the devices 54-62, though in some embodiments, each of the devices 54-62 may comprise a communication interface for enabling communication with other devices of the network 64. The remote device 14 of the wearable context network includes network software (NW SW) 66, a network database (NW DB) 68, and an application program interface (API) 70. One or more devices 71 of a third-party advertiser network are illustrated as communicating with the device(s) 14 of the wearable context network through the API 70.

In the example system 10 depicted in FIG. 1, the IOT devices 50 may be associated with certain contexts. For instance, the smart refrigerator 54 may be associated with a context of “meals,” of type “home.” The smart thermostat 56 may be associated with a context of “safety” and of type, “home.” The vendor POS 58 may be a company cafeteria, with a context of meals and a type, “restaurant.” The contests and type associated with the gym equipment 60 and restaurant POS device 62 may comprise gym, upper/lower body and meals, restaurant, respectively. Note that the context and/or type associations may have different labels in some embodiments, and that those described above are merely for illustration.

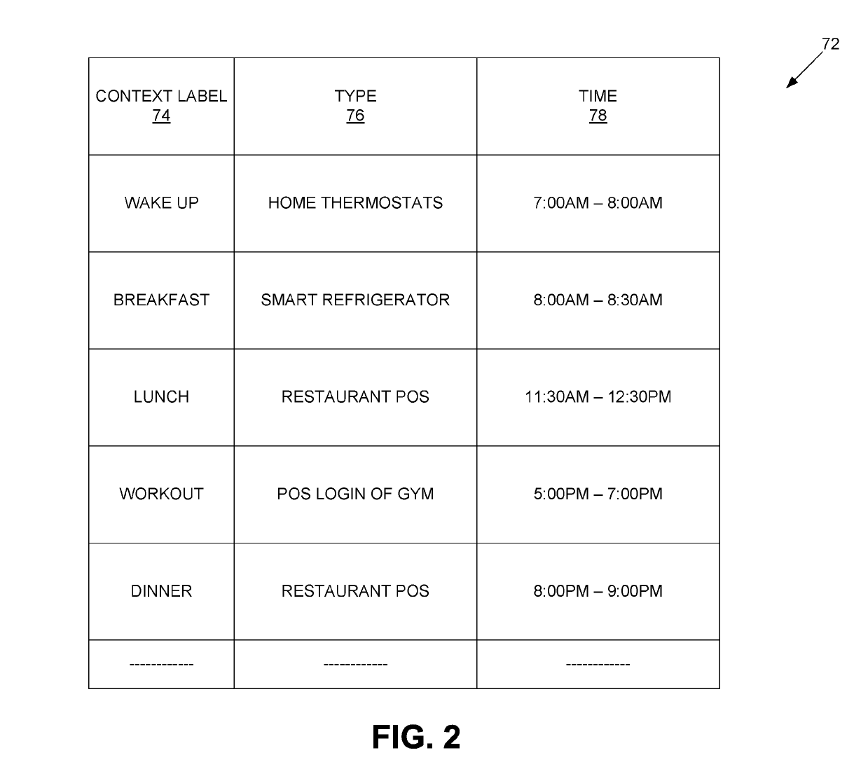

FIG. 2 illustrates an example table 72 of information that may be stored in the lookup context database 44 (FIG. 1). Columns in the table 72 include context label 74, type 76, and time 78 (e.g., time is one example of a time component). The context label 74 column is used (e.g., by the wearable device 12, FIG. 1) to track various events performed by a user of the wearable device 12. The example events with an associated label in the context label 74 column include waking up, eating breakfast, eating lunch, working out, and eating dinner, though fewer or more or different events may be associated with a context label 74 in some embodiments. Referring also to FIG. 1, each of these events may correspond to one or more types of IOT devices 50, such as the home thermostat 56, the smart refrigerator 54, the point-of-sale terminal 62 at a restaurant, and the point-of-sale login terminal 60 at the gym. Each of the context labels 74 in FIG. 2 corresponds with a time 78 (which may comprise a time component, such as absolute (e.g., time stamp), relative, or event-based time or time ranges). For example, when the user wakes up at home, a thermostat may turn the heater on between the hours of 7 and 8 AM in the morning.

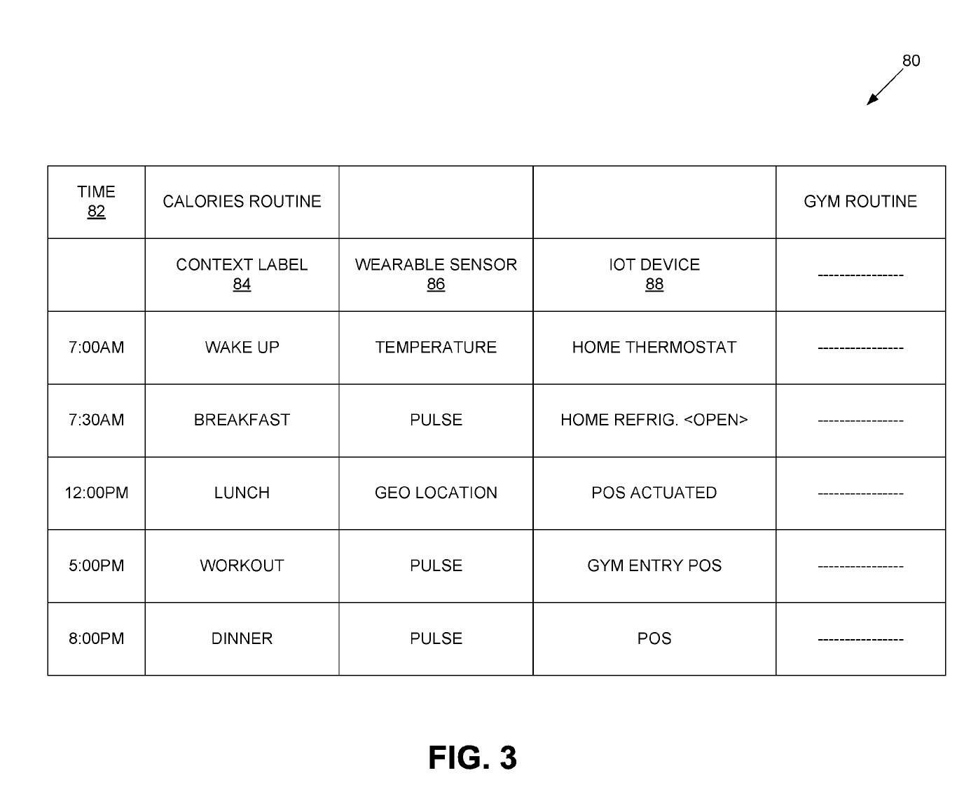

FIG. 3 illustrates an example table 80 of information that may be stored in the example ideal sequence database 42 (FIG. 1) that corresponds to an ideal sequence of events (in this example, for a calories routine, though other routines such as gym routine, etc. may also have corresponding values in the table 80 or other tables) that a user of the wearable device 12 (FIG. 1) may follow throughout a predetermined period of time, such as in this example, a day. The ideal sequence database 42 includes the table 80 (or in some embodiments, plural tables) that correlates a time entry 82 to a context label entry 86 associated with an event, to a wearable sensor physiological or behavioral data entry 88, and to an IOT device entry 88. For example, a second row in the table 80 correlates the time entry 82 of 7:30 AM to a context label entry 84 identified as breakfast time, to a wearable sensor physiological or behavioral data entry 88 corresponding to a pulse sensor, and to IOT device entry 88 (e.g., corresponding to a home refrigerator 54 (FIG. 1) that may open automatically as a user of a wearable device 12, FIG. 1) approaches the refrigerator. The wearable device and one or more network-connected devices (10T devices 50, FIG. 1) may send activity data to devices 14 (FIG. 1) of a wearable context network, and the wearable context network devices 14 may send messages to the wearable device 12.

Note that the table 80 may incorporate additional data (or be linked to one or more additional tables). For instance, in one embodiment, the context label entries 84 and time entries 82 may be modified to incorporate state data that correspond to sustained activity and/or stationary states of the user that are initiated as events. For example, when a user sits on a chair in an office, it is an event. Yet, sitting in that chair for a sustained period of time comprises a sustained state associated with that event of sitting. Should the user remain seated for an extended period of time (e.g., thirty (30) minutes, the wearable device 12 (FIG. 1) may send a message to the user to rise and optionally move around. In some embodiments, a probability component may be included in the table 80. For instance, though a personalized schedule for the user is described above as a pre-scripted sequence of events, in some embodiments, the wearable device 12 processes the events (and states) and a description of how the different events may follow one another in time. In one embodiment, the description may be a Markov model or a more generic probabilistic model that describes the probabilities for transitions from one event or activity to another, taking into account historical events (and states) (e.g., that have already taken place in the past). Alternatively, in one embodiment, the schedule is more deterministic, where the events/states are pre-defined or pre-scripted and transitions are fully deterministic and only depend on the previous state.

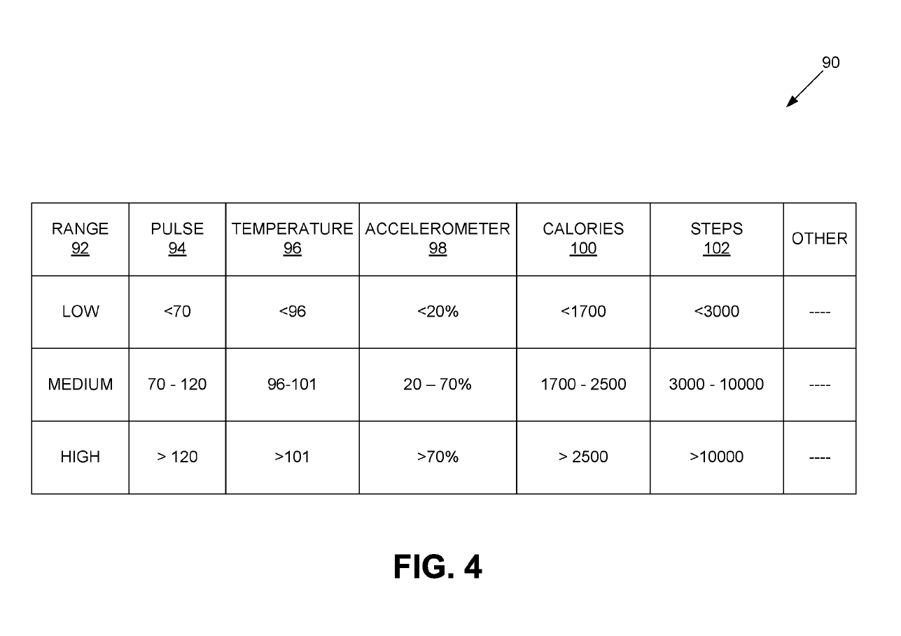

FIG. 4 illustrates an example table 90 that may be stored in the ideal sensor database 48 (FIG. 1). The table 80 includes various column entries that include range data 92, pulse rate data 94, temperature measurements 96, accelerometer data 98, calories burned 100, and step counts 102. In some embodiments, additional, fewer, and/or different column entries may be used. The table 90 of the ideal sensor database 48 may include information that corresponds to a precise measurement or to a range of measurements. In certain instances a measurement or a range of measurements may correspond to a period of low, medium, or high activity as measured by a sensor at the wearable device 12 (FIG. 1). The table of FIG. 4 illustrates a series of pulse rates 94, a measured temperature 96, accelerometer readings 98, caloric information 100, and steps 102 that correspond to a low, medium, or high level of activity. For example, a medium heart rate 94 is identified as being between 70 and 120 bpm, a medium temperature 96 is identified as being between 96 and 101 degrees F., a caloric burn rate 100 is identified as varying from 1700-2500 calories per day, and a number of steps 102 is identified as being between 3000 and 10000 steps per day.

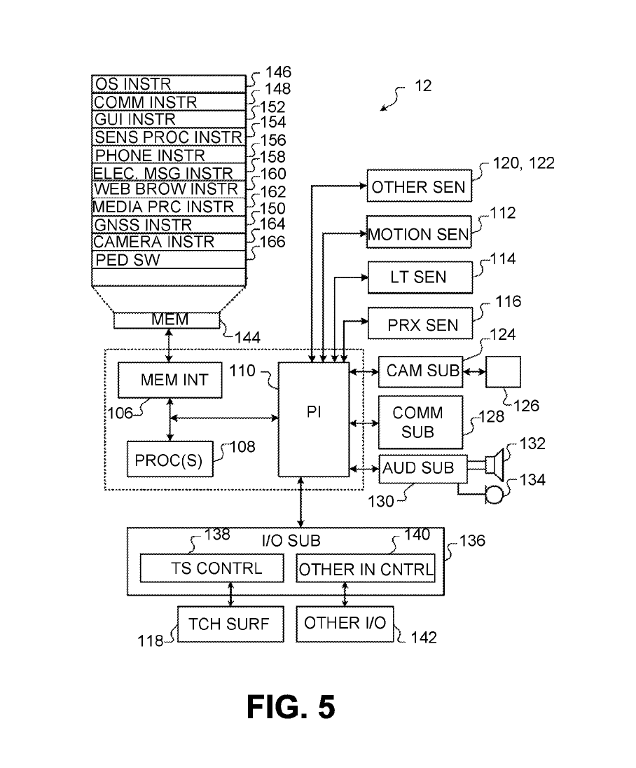

FIG. 5 illustrates an example architecture for the wearable device 12 or other mobile device that may be utilized to implement the various features and processes described herein. In other words, the architecture may be implemented in any number of portable devices including but not limited to smart wearable devices. The wearable device 12 as illustrated in FIG. 5 includes memory interface (MEM INT) 106, one or more processors (PROC(S)) 108, and peripheral interface (PI) 110. Memory interface 106, processors 108 and peripherals interface 110 may be separate components or may be integrated as a part of one or more integrated circuits. The various components may be coupled by one or more communication buses or signal lines. The processors 106 as illustrated in FIG. 5 are meant to be inclusive of data processors, image processors, a central processing unit, or any variety of multi-core processing devices. Any variety of sensors, external devices, and external subsystems may be coupled to the peripherals interface 110 to facilitate any number of functionalities within the wearable device 12. For example, motion sensor (MOTION SEN) 112, light sensor (LT SEN) 114, and proximity sensor (PRX SEN) 116 may be coupled to peripherals interface 110 to facilitate orientation, lighting, and proximity functions of the wearable device 12. For example, the light sensor 114 may be utilized to facilitate adjusting the brightness of a touch surface (TCH SURF) 118. The motion sensor 112, which may be used in the context of accelerometer or gyroscope functionality, may be utilized to detect movement and orientation of the wearable device 12. Display objects or media may then be presented according to a detected orientation (e.g., portrait or landscape).

Other sensors 120 may be coupled to peripherals interface 110, such as a temperature sensor, a biometric sensor, or other sensing device to facilitate corresponding functionalities. A location processor 122 (e.g., a global positioning transceiver or receiver) may be coupled to peripherals interface 110 to enable generation of geolocation data to thereby facilitating geo-positioning. An electronic magnetometer (not shown), such as an integrated circuit chip, may in turn be connected to peripherals interface 110 to provide data related to the direction of true magnetic North whereby the wearable device may enjoy compass or directional functionality. Camera subsystem 124 and an optical sensor 126 such as a charged coupled device (CCD) or a complementary metal-oxide semiconductor (CMOS) optical sensor may facilitate camera functions such as recording photographs and video clips.

Communication functionality may be facilitated through one or more communication subsystems 128, which may include one or more wireless communication subsystems. Communication subsystems 128 may include 802.5 or Bluetooth transceivers as well as optical transceivers such as infrared. Communication subsystems 128 may also include a wired communication sub-system, which may include a port device such as a Universal Serial Bus (USB) port or some other wired port connection that can be used to establish a wired coupling to other computing devices such as network access devices, personal computers, printers, displays, or other processing devices capable of receiving or transmitting data. The specific design and implementation of the communication subsystem 128 may depend on the communication network or medium over which the wearable device is intended to operate. For example, the wearable device 12 may include wireless communication subsystem designed to operate over a global system for mobile communications (GSM) network, a GPRS network, an enhanced data GSM environment (EDGE) network, 802.5 communication networks, code division multiple access (CDMA) networks, or Bluetooth networks. The communication subsystem 128 may include hosting protocols such that the wearable device 12 may be configured as a base station for other wireless devices. The communication subsystem 128 may also allow the wearable device 12 to synchronize with a host device using one or more protocols such as TCP/IP, HTTP, or UDP.

An audio subsystem 130 may be coupled to a speaker 132 and one or more microphones 134 to facilitate voice-enabled functions. These functions might include voice recognition, voice replication, or digital recording. The audio subsystem 130 may also encompass traditional telephony functions. An I/O subsystem 136 may include a touch controller 138 and/or other input controller(s) (OTHER IN CNTRL) 140. The touch controller 138 may be coupled to the touch surface 118. The touch surface 118 and touch controller 138 may detect contact and movement or break thereof using any of a number of touch sensitivity technologies, including but not limited to capacitive, resistive, infrared, or surface acoustic wave technologies. Other proximity sensor arrays or elements for determining one or more points of contact with the touch surface 118 may likewise be utilized. In one implementation, the touch surface 118 may display virtual or soft buttons and a virtual keyboard, which may be used as an input/output device by the user. Other input controllers 140 can be coupled to other input/control devices 142 such as one or more buttons, rocker switches, thumb-wheels, infrared ports, USB ports, and/or a pointer device such as a stylus. The one or more buttons (not shown) can include an up/down button for volume control of the speaker 132 and/or the microphone 134. In some implementations, the wearable device 12 may include the functionality of an audio and/or video playback or recording device and may include a pin connector for tethering to other devices.

The memory interface 166 may be coupled to memory 144. Memory 144 may include high-speed random access memory or non-volatile memory such as magnetic disk storage devices, optical storage devices, or flash memory. Memory 144 may store operating system (OS) instructions 146, where the operating system may include Darwin, RTXC, LINUX, UNIX, OS X, ANDROID, WINDOWS, or an embedded operating system such as VXWorks. The operating system instructions 146 may include instructions for handling basic system services and for performing hardware dependent tasks. In some implementations, the operating system instructions 146 may include a kernel.

Memory 144 may also store communication instructions (COMM INSTR) 148 to facilitate communicating with other mobile computing devices or servers. The communication instructions 148 may also be used to select an operational mode or communication medium for use by the wearable device 12 based on a geographic location, which may be obtained by GNSS instructions 150. Memory 144 may include graphical user interface instructions (GUI INSTR) 152 to facilitate graphic user interface processing such as the generation of an interface; sensor processing instructions (SENS PROC INSTR) 154 to facilitate sensor-related processing and functions; phone instructions (PHONE INSTR) 156 to facilitate phone-related processes and functions; electronic messaging instructions (ELEC MSG INSTR) 158 to facilitate electronic-messaging related processes and functions; web browsing instructions (WEB BROW INSTR) 160 to facilitate web browsing-related processes and functions; media processing instructions (MEDIA PRC INSTR) 162 to facilitate media processing-related processes and functions; the GNSS instructions 150 to facilitate GPS and/or other navigation-related processes, camera instructions (CAMERA INSTR) 164 to facilitate camera-related processes and functions; and instructions (PED INSTR) 166 for any other application that may be operating on or in conjunction with the wearable device 12. Memory 144 may also store other software instructions for facilitating other processes, features and applications, such as applications related to navigation, social networking, location-based services or map displays.

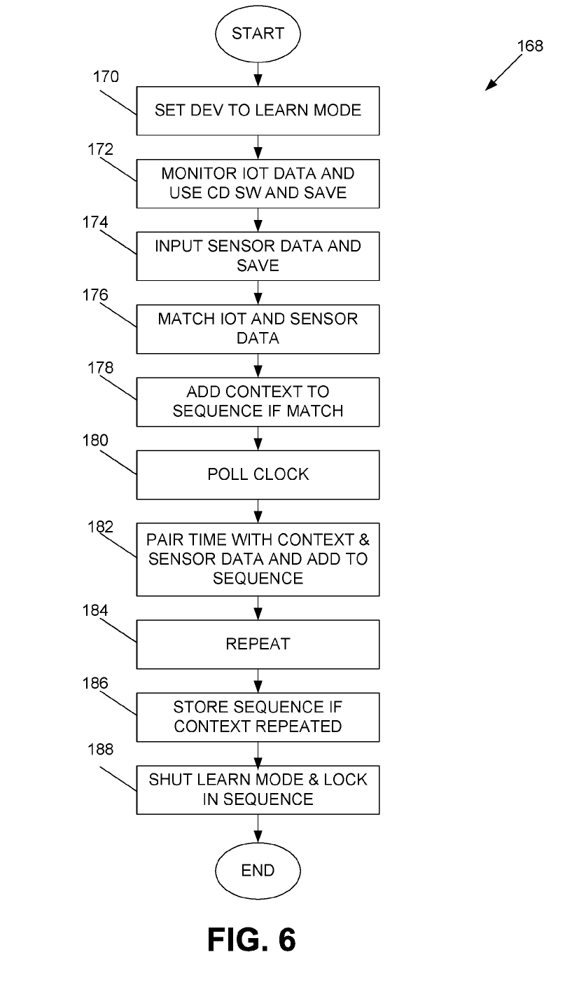

FIG. 6 is a flow diagram that illustrates an example process 168 performed by sequence build software 24 (FIG. 1) running on a processor or processors of the wearable device 12 in accordance with an embodiment of the invention. After a start, the process 168 comprises enabling a user to set the wearable device 12 (FIG. 1) into a learn mode (170). In certain instances the learn mode may span predetermined period of time, such as a day, a week, or a month. In (172), the process 168 comprises monitoring data from one or more IOT devices 50 (FIG. 1) as the user of the wearable device 12 performs a series of routine events. For instance, the IOT data may be monitored from any device that is polling the wearable device 12, and the context detection software 26 may be used and then the data stored in the wearable database 46 (FIG. 1). In (174), sensor data may be sensed at the wearable device 12 and the wearable device 12 may store the sensed data in a database (e.g., the wearable database 46, or in some embodiments, the sensor ideal database 48 of FIG. 1). At this point in time the wearable device 12 may also store information relating to activity level, a location or a geo-location of the wearable device 12, a heart rate of the user of the wearable device 12, or a blood pressure rate reading made by a sensor at the wearable device 12.

In (176), the process 168 may identify a context that correlates the received sensor data to information received from one or more of the IOT devices 50 (FIG. 1), such as via use of the lookup context database 44 (FIG. 1). When the context software identifies a match between sensor data and the IOT device data, the process 168 may prepare a context match data entry for storage in the wearable device database 46 (178). The context match entry may include a timestamp that identifies when the entry was prepared (180). The context match entry may then be stored in the wearable device database 46 (FIG. 1) (182). Then in (184) sensor data and the IOT device data may be collected repetitively over a period of time. Once enough sequence data has been acquired, the sequence data may be stored in the ideal sequence database (42, FIG. 1) (186). For example, if a particular sequence were repeated three times over a 10 day period, the sequence data may be recorded as part of a personalized schedule. The ideal sequence database data may be used when identifying when sensed data matches a sequence of activity. Finally, in (188), a user is allowed to turn off the learn mode and user alerts or messages are locked in. These alerts or message may help the user of the wearable device 12 to maintain an ideal schedule of events.

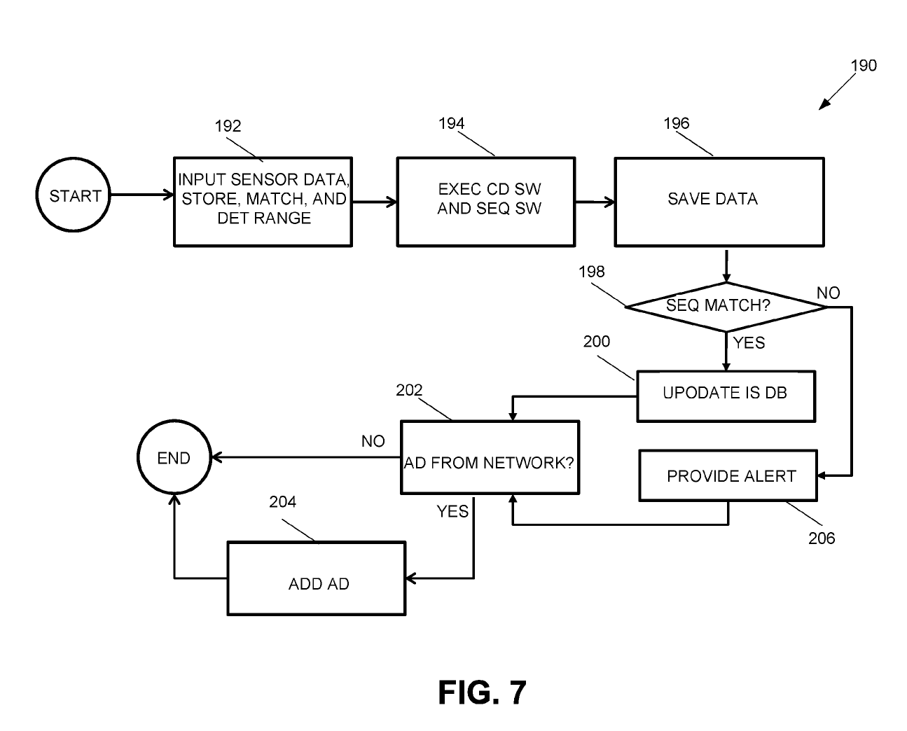

FIG. 7 is a flow diagram that illustrates an example process 190 performed by the base software 22 (FIG. 1) running on a processor of the wearable device 12 in accordance with an embodiment of the invention. The process 190 begins with input of sensor data (192). The wearable device sensor data may be stored in the wearable database 46 (FIG. 1) and that data may be used when identifying a matching sequence of events. In certain instances the sensor data may match data stored in the ideal sensor database 48 (FIG. 1). In (194), the process 190 further comprises a step in which the context detection software 26 (FIG. 1) may be executed when looking up a context in the lookup context database 44 (FIG. 1). The process 190 further comprises a step in which the data may be saved in the wearable database 46 (196). This data may include raw sensor data, time data, and context data that may correspond to a sequence. In (198), a determination is made as to whether a sequence has been matched. When a sequence has been matched (YES), program flow moves to (200) where data in the ideal sequence database 42 is updated. The process 190 further comprises a second determination step (202) that determines whether an advertisement has been provided by the wearable context network device 14 (FIG. 1) that may be displayed on display screen at the wearable device 12. When there is an advertisement (YES), the advertisement may be added to the context alert GUI 30 (FIG. 1) and displayed on the display screen 36 (FIG. 1) at the wearable device 12 (204). When there is no advertisement (NO at 202) to display, the process flow ends. When there is a determination at (198) that a sequence has not been matched, an alert may be sent to the context alert GUI 30 at the wearable device 12 (206) and program flow then moves to the second determination step at 202.

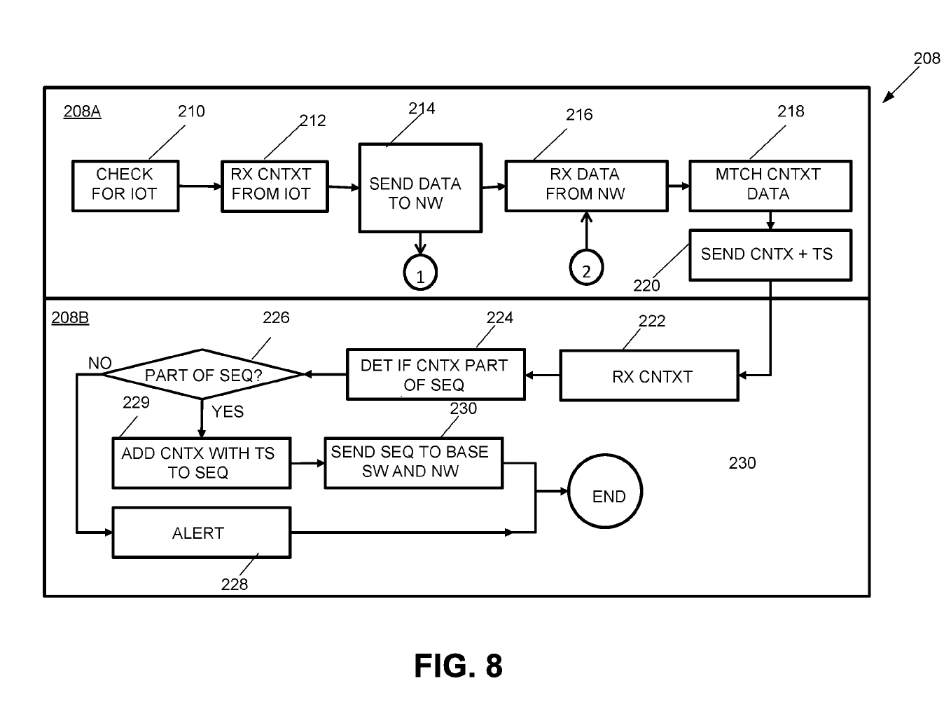

FIG. 8 is a flow diagram that illustrates an example process 208A performed by the context detection software 26 (FIG. 1) and a process 208B performed by the sequence software 28 (FIG. 1) running on a processor of the wearable device 12 in accordance with an embodiment of the invention. The process is collectively referred to by reference number 208. The process 208 reveals that, at least in one embodiment, the context detection software 26 communicates with the sequence software (28). In (210), the process 208A determines whether a connection is established with one or more of the IOT devices 50, or if a signal from one or more of the IOT devices 50 is being received. In (212), context information may be received from the one or more IOT devices. In (214), data may be sent to a wearable context network, as indicated by the encircled “1” in FIG. 8. In certain instances that data may include a geolocation, a point-of-sale location, or other information collected by the wearable device 12. Also, the process 208A further comprises a step (216) in which the wearable device 12 may receive results (e.g., a vendor name and/or location) from the device 14 (FIG. 1) of the wearable context network, as indicated by the encircled “2” in FIG. 8. The process 208A further comprises a step (218) that matches context data received at the wearable device 12 with information stored in the lookup context database 44 (FIG. 1). For example, context data received by the wearable device 12 may match information stored in the lookup context database. When such a match is identified, a message recommending, for instance, a nearby restaurant may be displayed on the display screen 36 at the wearable device 12. In (220) of the process 208A, context information may be sent to the sequence software 28 (FIG. 1), which implements the process 208B.

After the context information has been received (222) by the sequence software 28, a determination may be made that the context corresponds to an entry in the ideal sequence database 42 (FIG. 1). When the process 208B determines that the context information corresponds to a sequence, a context timestamp may be added to a current sequence entry, and that sequence entry may then be sent to the base software 22 (FIG. 1), wherein a determination is made as to whether the context is part of a sequence based on the ideal sequence database 42 (224). When the received context information is not part of the sequence (NO at 226), an alert (e.g., message) may be displayed (228) on the display screen 36 (FIG. 1) at the wearable device 12 that indicates that this context information does not correspond to a known sequence. In other words, if the wearable sensors 38 (FIG. 1) are out of range for that event or the event is not in the sequence (e.g., there was an extra restaurant visit), or stated otherwise, the event is not in compliance, the user is notified. After this step the sequence software program flow ends. If a determination is made at (226) that the context is part of the sequence (YES), the process 208B adds the context with its sequence (229) and sends the sequence to the base software 22 (FIG. 1) and the device 14 of the wearable context network (230) and the process ends.

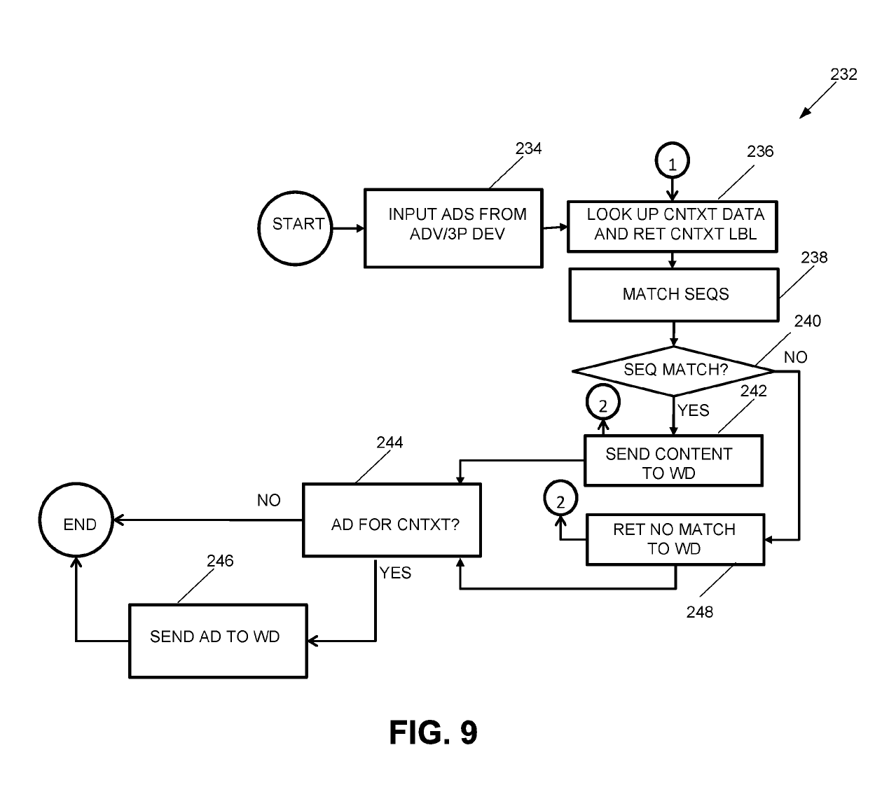

FIG. 9 is a flow diagram that illustrates an example process 232 performed by the network software 66 (FIG. 1) that may run on a processor on the remote device 14 (FIG. 1) of the wearable context network in accordance with an embodiment of the invention. In a first step (234) of the process 232, a third party advertiser may be allowed to provide advertisements and content over the API 70 (FIG. 1) at the remote device 14. The advertisements and content entered over the API 70 may be stored in the network database 68 (FIG. 1) in this step. In (236) of the process 232, a request is received from the wearable device 12 (from “1” in FIG. 8) to look up context data and cross-reference the context data with a context label. When a set of context data matches a sequence (YES in 238, 240), program flow moves to a step (242) where data (content) may be sent to the wearable device 12 (as indicated by the “2” in FIGS. 8-9). A second determination step (244) may then determine whether an advertisement for this context corresponds to the identified matched context in the network database 68. When there is a match (YES to 244), program flow moves to a step where the advertisement is sent to the wearable device 12 and that advertisement may be displayed in the context alert GUI 30 (FIG. 1) on a display screen 36 (FIG. 1) at the wearable device 12 (246). When there is no advertisement data (NO at 244), program flow ends. When the first determination step (240) determines that the sequence has not been matched (NO at 240), a message may be sent to the wearable device 12 (as indicated by the “2” in FIGS. 8-9) indicating that no match was found (248), and then program flow may move to the second determination step (244).

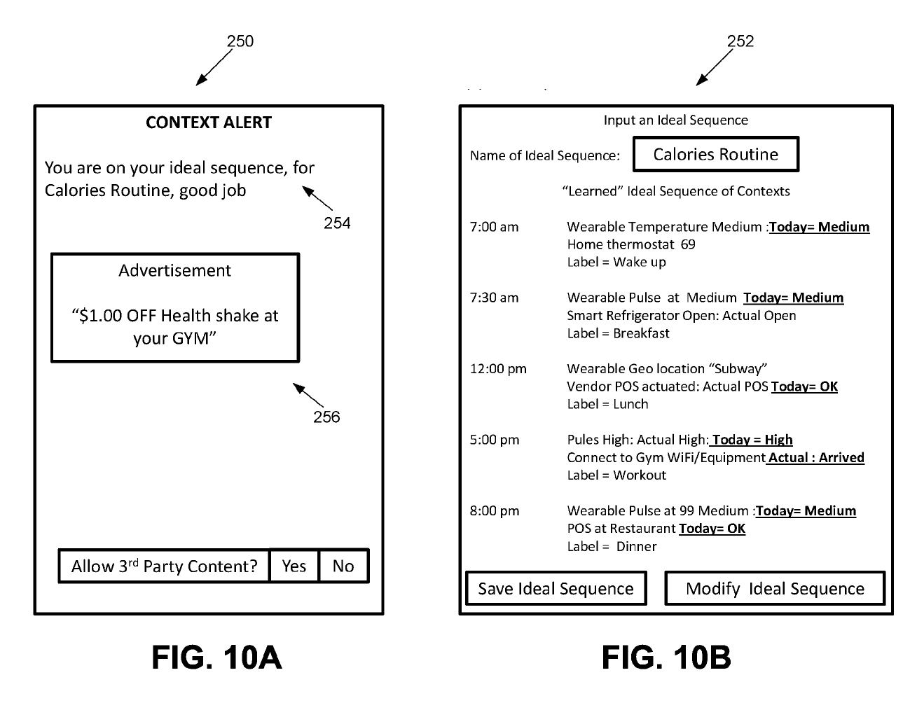

FIGS. 10A-10B are screen diagrams that illustrate example context alert 250 and ideal sequence graphical user interfaces (GUIs) 252 that may be displayed on the display screen 36 (FIG. 1) of the wearable device 12 (FIG. 1) in accordance with an embodiment of the invention. In these examples, the user is in compliance with a schedule. The context alert GUI 250 includes an example encouraging message 254 that states: “you are on your ideal sequence for calories routine, good job.” The context alert GUI 250 also includes an advertisement 256 for $1.00 off of a health shake at your gym, although other incentivizing messages may be used. A selection box in the context alert GUI 250 allows a user of the wearable device 12 to enable or disable receiving third-party content. The ideal sequence GUI 252 illustrated in FIG. 10B identifies an ideal sequence of a calorie routine. The GUI 252 indicates that the ideal sequence was learned. The GUI 252 includes various times, sensor data information, and information corresponding to various network-connected devices. The ideal sequence GUI 252 tracks the activity or behavior of the user of the wearable device 12 beginning at 7 AM and continues tracking the activity of the user until 8 PM. Information presented in the ideal sequence GUI 252 correlates sensor measurements or received data with information that may correspond to a labeled event. For example, at 7:30 AM the pulse rate of user was at a medium level when the user approached a smart refrigerator to eat breakfast (a labeled event). In another example, at 12 PM, the geolocation of the wearable device 12 was at the Subway restaurant when the wearable device 12 receives information from a vendor's point-of-sale terminal that indicates where the user of the wearable device 12 ate lunch. The ideal sequence GUI 252 illustrated in FIG. 10B also includes selection boxes that allow a user of the wearable device 12 to save an ideal sequence or modify the ideal sequence before saving it.

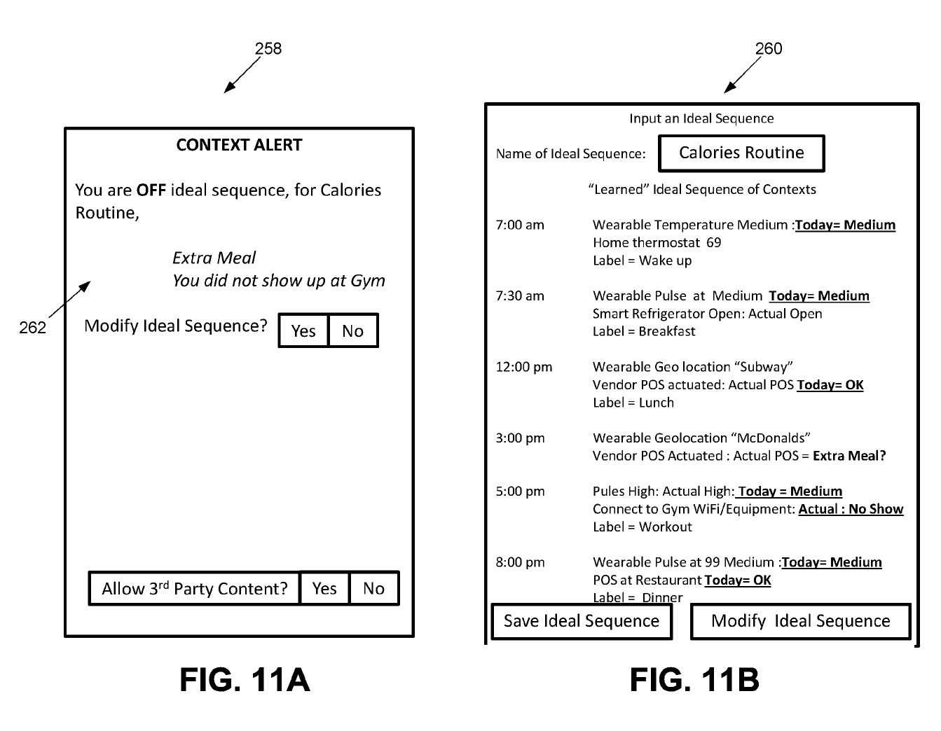

FIGS. 11A-11B illustrate the context alert GUI 258 and an ideal sequence GUI 260 in an instance where the user wearable device 12 is not meeting a personalized schedule (e.g., out of compliance). The context alert GUI 258 includes a message 262 that states: you are OFF your ideal sequence for your calories routine, extra meal, you did not show up at the gym. The context alert GUI 258 of FIG. 11A also includes a selection box where the user of the wearable device 12 may modify an ideal sequence. The context alert GUI 258 also includes an allow third-party content enable or disable selection box. The ideal sequence GUI 260 in FIG. 11B includes similar information as the information included in the ideal sequence GUI 252 of FIG. 10B. The ideal sequence GUI 260 of FIG. 11B however includes a wearable geolocation of McDonalds that corresponds to network-connected point-of-sale purchase where the user of the wearable device 12 purchased food and may have eaten an extra meal.

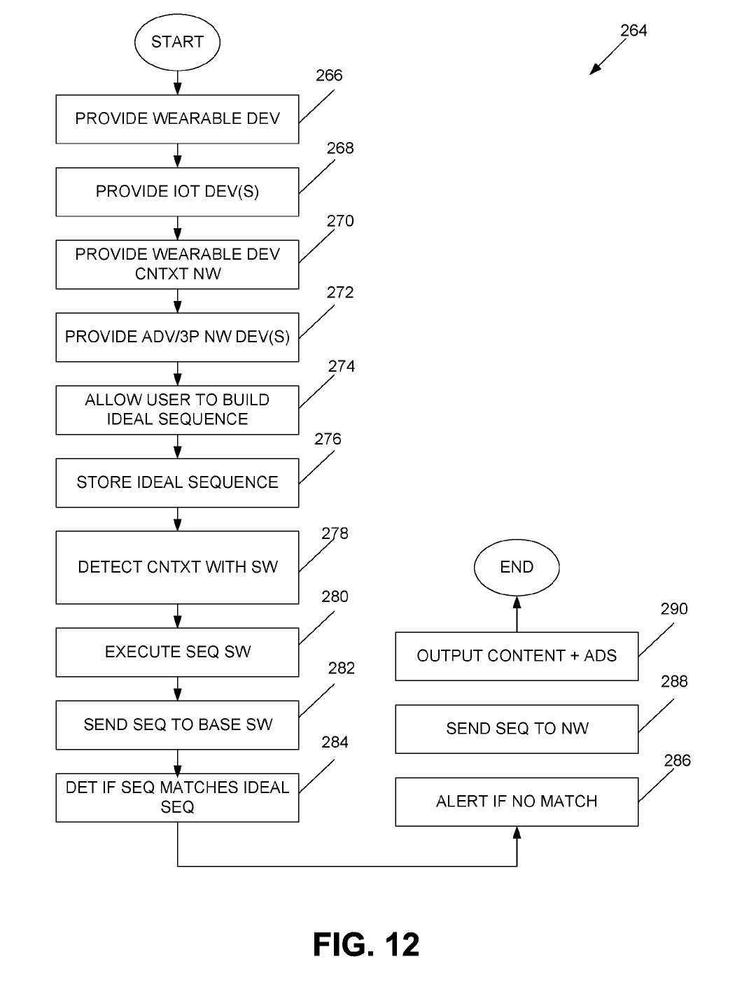

FIG. 12 is a flow diagram that illustrates an example method 264 that may be implemented in the system 10 depicted in FIG. 1 in accordance with an embodiment of the invention. A first step (266) of the method of FIG. 12 is a step where a wearable device 12 may be provided with base software 22 (FIG. 1), context detection software 26 (FIG. 1), sequence software 28 (FIG. 1), sensors 38 (FIG. 1), an ideal sensor database 48 (FIG. 1), a GNSS geolocation capability 40 (FIG. 1), a communication interface 16 (FIG. 1), a wearable database 46 (FIG. 1), an ideal sequence database 42 (FIG. 1), a look up context database 44 (FIG. 1), a power supply 20 (FIG. 1), and a display screen 36 (FIG. 1). In (268), a plurality of network-connected devices 50 (FIG. 1) may be provided with a communication interface (52, FIG. 1). In (270), the remote device 14 of the wearable context network is provided with network software 66 (FIG. 1), a network database 68 (FIG. 1), and an API (70). In (272), a device 71 (FIG. 1) of a third-party advertiser network may be provided with context or advertisement information. In (274), a user of the wearable device 12 is allowed to designate an ideal sequence of contexts that corresponds to a sequence of events. Information corresponding to an ideal sequence of contexts may be entered or modified over a GUI at the wearable device 12. In (276), an identified context sequence may be stored in the ideal sequence database 42. In (278), the context detection software 26 may detect a context, and in (280), the sequence software 28 may be executed on a processor of the wearable device 12. In (282) of the method 264, a sequence of contexts may be sent to the base software 22. The base software 22 may determine in (284) whether the sequence matches an ideal sequence of contexts that are stored in ideal sequence database 42. In (286), a user may be sent an alert. The alert may indicate that the current sequence does not match an ideal sequence. The alert may be presented as a message in an alert GUI at the wearable device 12. Alternatively the alert may cause a ring a ring tone to ring or may initiate a vibration at the wearable device. In (288), a sequence may be sent to a remote device 14 of the wearable context network that is monitoring the activity of user of the wearable device 12. Finally, in (290), information may be presented on the display screen 36 at the wearable device 12 that identifies a known sequence of contexts. In certain instances an advertisement may be displayed on the display screen 36 at the wearable device 12.

Any process descriptions or blocks in the flow diagrams described above and illustrated in the accompanying figures should be understood as representing modules, segments, or portions of code which include one or more executable instructions for implementing specific logical functions or steps in the process, and alternate implementations are included within the scope of an embodiment of the present invention in which functions may be executed substantially concurrently, and/or additional logical functions or steps may be added, depending on the functionality involved, as would be understood by those reasonably skilled in the art of the present invention.

In one embodiment, a claim to an apparatus is disclosed, comprising wearable sensors; and a processor configured to track a plurality of events experienced by a subject, wherein for each of the plurality of events, the processor is configured to: automatically receive from one of a plurality of network-connected devices first data associated with the each of the events; automatically receive from one or more wearable sensors second data, the second data corresponding to any one or a combination of a physiological and behavioral parameter associated with the each of the events; compare the first and second data with stored contexts having respective context labels to identify a match between the first and second data and one of the stored contexts; responsive to the match between the first and second data and the one of the stored contexts, determine whether the first and second data corresponds in time of receipt by the processor with a time component of the one of the stored contexts in a personalized schedule of a data structure; and provide feedback to the subject conveying either compliance or non-compliance with the schedule based on the determination.

The apparatus of the prior claim, wherein responsive to a determination that the first and second data do not correspond in time of receipt by the processor with the time component of the one of the stored contexts in the schedule of the data structure, the processor is further configured to provide an alert to the subject. In one embodiment, the alert comprises a message that the subject is out of compliance with the schedule. In one embodiment, the first and second data comprise an event and associated state, wherein the alert is provided based on the state exceeding the time component.

The apparatus of the first claim, wherein responsive to a determination that the first and second data correspond in time of receipt by the processor with the time component of the one of the stored contexts in the schedule of the first data structure, the processor is further configured to update the first data structure.

The apparatus of the immediately prior claim, wherein the processor is further configured to provide a message to the subject, the message conveying compliance by the subject with the schedule.

The apparatus of the first claim, wherein the processor is further configured to: provide the first and second data to a remote device; receive information from the remote device based on the first and second data; and based on the determination that the first and second data correspond in time of receipt by the processor with the time component of the one of the stored contexts in the schedule of the first data structure, cause a presentation of the information to the subject.

The apparatus of the immediately prior claim, wherein the information comprises an advertisement or an incentive and/or wherein the information comprises a point-of-sale name and corresponding location.

The apparatus of the first claim, wherein the processor is further configured to cause a presentation of the first and second data and associated time component along with data of the first data structure and associated time components, the presentation further including a sensor range indication.

The apparatus of the first claim, wherein the processor is further configured to, prior to receipt of the first and second data: automatically receive third data from at least one of a plurality of network connected devices; automatically receive fourth data from one or more of the wearable sensors, the fourth data corresponding to any one or a combination of a physiological and behavioral parameter; determine if there is a match between one of the events corresponding to a combination of the third and fourth data and a stored context having an associated context label; and responsive to the determination of a match, associate the one of the events with the stored context and a current time component, wherein responsive to each one of the events that the processor associates with a same one of the stored contexts a threshold plurality of times over a predetermined period of time, the processor is configured to automatically store the each one of the events as part of the personalized schedule in the first data structure along with a probability of an expected order of occurrence for the plurality of stored events.

The apparatus of the immediately prior claim wherein one or more of the plurality of events includes a state corresponding to one of the respective events, the state comprising a sustained period of activity or inactivity associated with the event. In one embodiment, the processor is configured to determine the probability based on execution of any one or a combination of a Markov model or probabilistic graphic model. In one embodiment, the predetermined period of time comprises a day, a week, or a month.

The apparatus of the first claim, wherein the second data further comprises location data.

In one embodiment, a claim to a non-transitory, computer readable medium comprises executable code that is executed by a processor to cause the processor to track a plurality of events experienced by a subject is disclosed, wherein for each of the plurality of events, the executable code cause the processor to: automatically receive from one of a plurality of network-connected devices first data associated with the each of the events; automatically receive from one or more wearable sensors second data, the second data corresponding to any one or a combination of a physiological and behavioral parameter associated with the each of the events; compare the first and second data with stored contexts having respective context labels to identify a match between the first and second data and one of the stored contexts; responsive to the match between the first and second data and the one of the stored contexts, determine whether the first and second data corresponds in time of receipt by the processor with a time component of the one of the stored contexts in a personalized schedule of a data structure; and provide feedback to the subject conveying either compliance or non-compliance with the schedule based on the determination.

The non-transitory, computer readable medium of the prior claim, further comprising executable code that is executed by the processor to cause the processor to: generate the schedule based on a learning mode comprising data corresponding to events and states of the events experienced by the subject, the data received from wearable sensors and network-connected devices, the data associated with a probability of time components, the learning mode implemented over a predetermined period of time.

The first non-transitory, computer readable medium claim, further comprising executable code that is executed by the processor to cause the processor to: provide advertisements or incentives to the subject based on the determination of compliance; and provide point-of-sale name and location based on the first and second data.

The first non-transitory, computer readable medium claim, wherein the first and second data collectively comprise an event or an event and corresponding state, and wherein the processor is further configured to determine which of a plurality of ranges the first data falls within and provide feedback of that range.

In one embodiment, a method if disclosed, the method comprising: at a processor configured to track a plurality of events experienced by a subject, for each of the plurality of events: receiving from one of a plurality of network-connected devices first data associated with the each of the events; receiving from the one or more wearable sensors second data, the second data corresponding to any one or a combination of a physiological and behavioral parameter associated with the each of the events; comparing the first and second data with stored contexts having respective context labels to identify a match between the first and second data and one of the stored contexts; determining whether the first and second data corresponds in time of receipt by the processor with a time component of the one of the stored contexts in a personalized schedule of a data structure responsive to the match between the first and second data and the one of the stored contexts; and providing feedback to the subject conveying either compliance or non-compliance with the schedule based on the determination.

While the invention has been illustrated and described in detail in the drawings and foregoing description, such illustration and description are to be considered illustrative or example and not restrictive; the invention is not limited to the disclosed embodiments. Other variations to the disclosed embodiments can be understood and effected by those skilled in the art in practicing the claimed invention, from a study of the drawings, the disclosure, and the appended claims. Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical medium or solid-state medium supplied together with or as part of other hardware, but may also be distributed in other forms. Any reference signs in the claims should be not construed as limiting the scope.

1. An apparatus, comprising:
wearable sensors; and
a processor configured to track a plurality of events experienced by a subject, wherein for each of the plurality of events, the processor is configured to:
automatically receive from one of a plurality of network-connected devices located proximally to the processor first data associated with the each of the events;
automatically receive from one or more wearable sensors second data, the second data corresponding to any one or a combination of a physiological and behavioral parameter associated with the each of the events;
for a given instance of time, compare the first and second data with a data structure comprising a sequence of events arranged temporally and contextually, the data structure comprising for each event of the sequence of events, plural associated entries corresponding to at least a time component, an indicia of the event, a sensed parameter associated with the one or more wearable sensors, and indicia of one of the network connected devices, the comparison to identify for the given instance of time a match between the first and second data and the plural entries of each of the events of the sequence of events; and
based on the comparison, determine compliance between the tracked event corresponding to the first and second data and the sequence of events of the data structure when there is a match and determine non-compliance between the tracked event and the sequence of events of the data structure when there is no match, wherein the processor is further configured to provide feedback to the subject conveying as applicable the compliance and the non-compliance.

2. The apparatus of claim 1, wherein responsive to the determination of non-compliance, the processor is further configured to cause a change in state of another device in communication with the apparatus or provide an alert to the subject.

3. The apparatus of claim 2, wherein the alert comprises a message that the subject is out of compliance with the schedule.

4. The apparatus of claim 2, wherein the first and second data comprise an event and associated state, wherein the alert is provided based on the state exceeding the time component.

5. The apparatus of claim 1, wherein responsive to the determination of compliance, the processor is further configured to update the first data structure.

6. The apparatus of claim 5, wherein the processor is further configured to provide a message to the subject, the message conveying compliance by the subject with the schedule.

7. The apparatus of claim 1, wherein the processor is further configured to:
provide the first and second data to a remote device;
receive information from the remote device based on the first and second data; and
based on the determination of compliance, cause a presentation of the information to the subject.

8. The apparatus of claim 7, wherein the information comprises an advertisement or an incentive.

9. The apparatus of claim 7, wherein the information comprises a point-of-sale name and corresponding location.

10. The apparatus of claim 1, wherein the processor is further configured to determine whether the second data is within one of a plurality of sensor operating range levels, and further to cause a presentation of a sensor range level indication.

11. The apparatus of claim 1, wherein the processor is further configured to, prior to receipt of the first and second data:
automatically receive third data from at least one of a plurality of network connected devices;
automatically receive fourth data from one or more of the wearable sensors, the fourth data corresponding to any one or a combination of a physiological and behavioral parameter;
determine if there is a match between one of the events corresponding to a combination of the third and fourth data and the sequence of events of the data structure; and
responsive to the determination of a match, associate the one of the events with one of the entries of the data structure,
wherein responsive to each one of the events that the processor associates with a same one of the entries of the data structure a threshold plurality of times over a predetermined period of time, the processor is configured to automatically store the each one of the events as part of the data structure along with a probability of an expected order of occurrence for the sequence of events.

12. The apparatus of claim 11, wherein one or more of the entries of the sequence of events in the data structure includes a state corresponding to one of the respective events, the state comprising a sustained period of activity or inactivity associated with the event.

13. The apparatus of claim 11, wherein the processor is configured to determine the probability based on execution of any one or a combination of a Markov model or probabilistic graphic model.

14. The apparatus of claim 11, wherein the predetermined period of time comprises a day, a week, or a month.

15. The apparatus of claim 1, wherein the second data further comprises location data.

16. A non-transitory, computer readable medium comprises executable code that is executed by a processor to cause the processor to track a plurality of events experienced by a subject, wherein for each of the plurality of events, the executable code cause the processor to:
automatically receive from one of a plurality of network-connected devices located proximally to the processor first data associated with the each of the events;
automatically receive from one or more wearable sensors second data, the second data corresponding to any one or a combination of a physiological and behavioral parameter associated with the each of the events;
for a given instance of time, compare the first and second data with a data structure comprising a sequence of events arranged temporally and contextually, the data structure comprising for each event of the sequence of events, plural associated entries corresponding to at least a time component, an indicia of the event, a sensed parameter associated with the one or more wearable sensors, and indicia of one of the network connected devices, the comparison to identify for the given instance of time a match between the first and second data and the plural entries of each of the events of the sequence of events; and
based on the comparison, determine compliance between the tracked event corresponding to the first and second data and the sequence of events of the data structure when there is a match and determine non-compliance between the tracked event and the sequence of events of the data structure when there is no match, wherein the executable code causes the processor to provide feedback to the subject conveying as applicable the compliance and the non-compliance.

17. The non-transitory, computer readable medium of claim 16, further comprising executable code that is executed by the processor to cause the processor to:
generate the data structure based on a learning mode comprising data corresponding to events and states of the events experienced by the subject, the data received from wearable sensors and network-connected devices, the data associated with a probability of time component, the learning mode implemented over a predetermined period of time.

18. The non-transitory, computer readable medium of claim 16, further comprising executable code that is executed by the processor to cause the processor to:
provide advertisements or incentives to the subject based on the determination of compliance; and
provide point-of-sale name and location based on the first and second data.

19. The non-transitory, computer readable medium of claim 16, wherein the first and second data collectively comprise an event or an event and corresponding state, and wherein the processor is further configured to determine which of a plurality of ranges the first data falls within and provide feedback of that range.

20. A method, comprising:
at a processor configured to track a plurality of events experienced by a subject, for each of the plurality of events:
receiving from one of a plurality of network-connected devices located proximally to the processor first data associated with the each of the events;
receiving from the one or more wearable sensors second data, the second data corresponding to any one or a combination of a physiological and behavioral parameter associated with the each of the events;
for a given instance of time, comparing the first and second data with a data structure comprising a sequence of events arranged temporally and contextually, the data structure comprising for each event of the sequence of events, plural associated entries corresponding to at least a time component, an indicia of the event, a sensed parameter associated with the one or more wearable sensors, and indicia of one of the network connected devices, the comparing to identify for the given instance of time a match between the first and second data and the plural entries of each of the events of the sequence of events;
based on the comparison, determining compliance between the tracked event corresponding to the first and second data and the sequence of events of the data structure when there is a match and determining non-compliance between the tracked event and the sequence of events of the data structure when there is no match; and
providing feedback to the subject conveying as applicable the compliance and the non-compliance.
